(19) United States
(12) Patent Application Publication
(10) Pub. No.: US 2017/0362539 A1
(43) Pub. Date: Dec. 21, 2017

(54) Liquid Laundry Detergent

(71) Applicant: The Procter & Gamble Company, Cincinnati, OH (US)

(72) Inventors: Jean-Pol Boutique, Gembloux (BE); Hugo Robert Germain Denutte, Hofstade (BE); Hazal Ozturk, Tervuren (BE); Emmanuel Marie Francois Rene De Reydet De Vulpillieres, Lincent (BE); Keven Vanhoof, Antwerp (BE); Giulia Ottavia Bianchetti, Brussels (BE)

(21) Appl. No.: 15/622,115

(22) Filed: Jun. 14, 2017

(30) Foreign Application Priority Data
Jun. 15, 2016 (EP) 16174516.1

(51) Int. Cl. C11D 1/42; C11D 3/50; C11D 3/43; C11D 3/39; C11D 10/04; C11D 3/04

(52) U.S. Cl. CPC C11D 1/42; C11D 3/50; C11D 3/04; C11D 3/3937; C11D 10/047; C11D 3/43

(57) ABSTRACT

A liquid laundry detergent composition comprising a perfume composition providing superior malodour neutralization of fabrics without causing a colour change of the composition.

### FIELD OF THE INVENTION

The present invention relates to a liquid laundry detergent composition comprising a perfume composition and to a unit dose article comprising said liquid laundry detergent composition.

### BACKGROUND OF THE INVENTION

It is well known that detergent perfumes are less effective in washing conditions where the level of soil is high. Reduced perfume deposition and soil left on fabrics may result in residual malodour. The inventors have found that specific perfume raw materials (PRM's) provide superior malodour neutralization of washed fabrics even when soil residues remain on the fabrics after washing. It was found however that, in the context of liquid laundry detergent composition the incorporation of some perfume raw material can lead to a formulation stability issue. Specifically, some of the perfume raw materials can react with alkanolamines which are conventionally used as a neutralizing agent in liquid laundry detergent compositions, leading to a colour change of said liquid laundry detergent compositions.

Thus, there is a need for a stable liquid laundry detergent composition comprising specific perfume raw materials providing superior malodour neutralization on washed fabrics without discoloration of the liquid laundry detergent composition.

### SUMMARY OF THE INVENTION

The inventors surprisingly found that the liquid laundry detergent composition of the present invention comprising specific perfume raw materials provides superior odour reduction of fabric odour without discoloration of the liquid laundry detergent composition.

It was also found that a water-soluble unit dose article comprising the liquid laundry detergent composition of the present invention also overcame the technical problem.

The present invention also relates to a unit dose article comprising the liquid laundry detergent composition of the present invention and a water soluble film, wherein said water-soluble film preferably comprises polyvinyl alcohol.

### DETAILED DESCRIPTION OF THE INVENTION

### Definitions

As used herein, the term “liquid laundry detergent composition” refers to detergent compositions that are in a form selected from the group consisting of liquid, gel, cream, and combinations thereof. The liquid laundry detergent composition can comprise solids or gases, but the liquid laundry detergent composition excludes forms which are non-liquid overall, such as tablets or granules. The liquid laundry detergent composition may be either aqueous or non-aqueous, and may be anisotropic, isotropic, or combinations thereof.

As used herein, the term “unit dose article” refers to a product comprising a water-soluble film and a liquid laundry detergent composition contained in the water-soluble film. The term “compartment” herein refers to a portion of the unit dose article in which a detergent composition is enveloped by the water-soluble film.

As used herein, the term “perfume composition”, refers to volatile oils comprising one or more perfume raw materials (PRMs) and optional solvents, in which no chemical compounds are intentionally added to combine or react with the PRMs, and therefore the PRMs are free to become volatized and available for olfactory detection by a user. The term “perfume delivery system” herein refers to the combination or reaction product of PRMs with certain chemical compounds, which enhances the deposition efficiency of the perfume onto a fabric and/or a controlled release of the perfume.

As used herein, the articles including “a” and “an” when used in a claim, are understood to mean one or more of what is claimed or described.

Unless otherwise noted, all component or composition levels are in reference to the active portion of that component or composition, and are exclusive of impurities, for example, residual solvents or by-products, which may be present in commercially available sources of such components or compositions.

All percentages and ratios are calculated by weight unless otherwise indicated. All percentages and ratios are calculated based on the total composition unless otherwise indicated. All measurements are performed at 25° C. unless otherwise specified.

### Liquid Laundry Detergent Composition

The pH range of the liquid laundry detergent composition is preferably from 5 to 11, more preferably from 6 to 10, even more preferably from 7 to 9. In a unit dose article execution, an alkaline composition (e.g., with a pH of from 7 to a pH of 9) is preferred due to being more compatible with the water-soluble film of the unit dose article, e.g., a polyvinyl alcohol film. The pH is measured on the composition diluted to 10% in water, at 25° C., using a Sartarius PT-10P pH meter with gel-filled probe (such as the Toledo probe, part number 52 000 100), calibrated according to the instructions manual.

Without wishing to be bound by theory, it is believed that reactions between perfume raw materials in the perfume composition and alkanolamines degrades the performance of both ingredients and causes a colour change of the composition. In order to minimize the colour change of the composition while providing superior malodour neutralization on the fabrics, it is necessary to replace the perfume raw materials that react with alkanolamines.

The liquid laundry detergent composition preferably have densities in the range from of 0.9 to 1.3 grams per cubic centimeter, more preferably from 1.00 to 1.1 grams per cubic centimeter, excluding any solid additives, but including any bubbles, if present.

### Alkanolamine

The liquid laundry detergent composition of the present invention comprises from 0.1% to 15%, preferably from 0.5% to 12%, more preferably from 5% to 10% by weight of the liquid laundry detergent composition of an alkanolamine.

Any suitable alkanolamine may be used in the present invention.

Preferably, the alkanolamine comprises mono ethanol amine, propaneolamine, triethanolamine, and combinations thereof, more preferably the alkanolamine is selected from mono ethanol amine or triethanolamine.

Particularly, the alkanolamine is utilized to neutralize anionic surfactants, such as Linear Alkylbenzene Sulfonate (LAS), or certain acidic ingredients, such as fatty acids, thus achieving a preferred alkaline composition.

### Perfume Composition

The liquid laundry detergent composition comprises from 0.5% to 3%, preferably from 0.9% to 2.5% by weight of the liquid laundry detergent composition of a perfume composition comprising:
i) a first perfume raw material selected from the group consisting of: allyl cyclohexane propionate, ambronate, amyl salicylate, bacdanol, benzyl acetate, benzyl propionate, benzyl salicylate, beta napthyl methyl ether, cashmeran, cetalox, cis-3-hexenol, cis-3-hexenyl acetate, cis-3-hexenyl salicylate, citronellol, citronellyl acetate, citronellyl nitrile, cyclabute, cyclogalbanate, cyclohexyl salicylate, cyclopentol, dihydro beta ionone, dihydro eugenol, dihydromyrcenol, dimethyl benzyl carbinyl acetate, dimethyl benzyl carbinyl butyrate, diphenyl oxide, ethyl amyl ketone, ethyl-2-methyl butyrate, ethyl-2-methyl pentanoate, eucalyptol, exaltolide, flor acetate, fructalate, frutene, geraniol, globanone, habanolide, heptyl acetate, hexyl acetate, hexyl salicylate, iris nitrile, iso E super, isobornyl acetate, isopropyl-2-methyl butyrate, lemonile, linalool, menthol, menthyl acetate, methyl benzoate, methyl beta naphtyl ketone, methyl dihydrojasmonate, methyl phenyl carbinyl acetate, mugetanol, muscenone delta, octahydro coumarin, octalynol, pandanol, para cresyl methyl ether, peonile, phenyl hexanol, prenyl acetate, pyranol, rose oxide, sanjinol, tetrahydrolinalool, undecalactone, verdox, vertenex, violet nitrile, Patchouli, Undecavertol, Orange oil cold pressed, and combinations thereof;

Without wishing to be bound by theory, said perfume raw materials provide superior malodour neutralization on the fabrics while not reacting with the alkanolamine and consequently not causing a colour change of the liquid laundry detergent composition.

Preferably, the perfume composition comprises the first perfume raw material selected from the group consisting of: Allyl Cyclohexane Propionate, Benzyl acetate, Cashmeran, Cetalox, Cis-3-Hexenyl Acetate, cis-3-Hexenyl salicylate, Citronellol, Citronellyl Nitrile, Cyclohexyl Salicylate, Cyclopentol, Muscenone delta, Dihydro Beta Ionone, Dihydro Eugenol, Dihydro Myrcenol, Dimethyl Benzyl Carbinyl acetate, Diphenyl Oxide, Ethyl 2-Methyl pentanoate, Ethyl 2-methylbutyrate, Ethyl Amyl Ketone, Eucalyptol, Flor Acetate, Frutene, Geraniol, Globanone, Habanolide, Hexyl Acetate, Hexyl salicylate, Iso Bornyl Acetate, Iso E super, Menthol, Methyl Benzoate, Methyl Dihydro Jasmonate, Para Cresyl Methyl Ether, Peonile, Sanjinol, Tetra Hydro Linalool, Undecalactone, Verdox, Patchouli, Undecavertol, Orange oil cold pressed and combinations thereof;

more preferably: Allyl Cyclohexane Propionate, Ambronat, Benzyl acetate, Cis-3-Hexenol, Cis-3-Hexenyl Acetate, cis-3-Hexenyl Salicylate, Cyclo Galbanate, Cyclohexyl Salicylate, Cyclopentol, Dihydro Myrcenol, Dimethyl Benzyl Carbinyl acetate, Ethyl 2-methylbutyrate, Flor Acetate, Geraniol, Globanone, Habanolide, Hexyl Acetate, Hexyl salicylate, Iso E super, Methyl Dihydro Jasmonate, Peonile, Phenyl hexanol, Tetra Hydro Linalool, Undecalactone, Verdox and Verdenex, Patchouli, Undecavertol, Orange oil cold pressed and combinations thereof.

The perfume composition may comprise the first perfume raw material selected from the group consisting of: allyl cyclohexane propionate, ambronate, amyl salicylate, bacdanol, benzyl acetate, benzyl propionate, benzyl salicylate, beta napthyl methyl ether, cashmeran, cetalox, cis-3-hexenol, cis-3-hexenyl acetate, cis-3-hexenyl salicylate, citronellol, citronellyl acetate, citronellyl nitrile, cyclabute, cyclogalbanate, cyclohexyl salicylate, cyclopentol, dihydro beta ionone, dihydro eugenol, dihydromyrcenol, dimethyl benzyl carbinyl acetate, dimethyl benzyl carbinyl butyrate, diphenyl oxide, ethyl amyl ketone, ethyl-2-methyl butyrate, ethyl-2-methyl pentanoate, eucalyptol, exaltolide, flor acetate, fructalate, frutene, geraniol, globanone, habanolide, heptyl acetate, hexyl acetate, hexyl salicylate, iris nitrile, iso E super, isobornyl acetate, isopropyl-2-methyl butyrate, lemonile, linalool, menthol, menthyl acetate, methyl benzoate, methyl beta naphtyl ketone, methyl dihydrojasmonate, methyl phenyl carbinyl acetate, mugetanol, muscenone delta, octahydro coumarin, octalynol, pandanol, para cresyl methyl ether, peonile, phenyl hexanol, prenyl acetate, pyranol, rose oxide, sanjinol, tetrahydrolinalool, undecalactone, verdox, vertenex, violet nitrile, Patchouli, Undecavertol, and combinations thereof.

The perfume composition may comprise the first perfume raw material selected from the group consisting of: allyl cyclohexane propionate, ambronate, amyl salicylate, bacdanol, benzyl acetate, benzyl propionate, benzyl salicylate, beta napthyl methyl ether, cashmeran, cetalox, cis-3-hexenol, cis-3-hexenyl acetate, cis-3-hexenyl salicylate, citronellol, citronellyl acetate, citronellyl nitrile, cyclabute, cyclogalbanate, cyclohexyl salicylate, cyclopentol, dihydro beta ionone, dihydro eugenol, dihydromyrcenol, dimethyl benzyl carbinyl acetate, dimethyl benzyl carbinyl butyrate, diphenyl oxide, ethyl amyl ketone, ethyl-2-methyl butyrate, ethyl-2-methyl pentanoate, eucalyptol, exaltolide, flor acetate, fructalate, frutene, geraniol, globanone, habanolide, heptyl acetate, hexyl acetate, hexyl salicylate, iris nitrile, iso E super, isobornyl acetate, isopropyl-2-methyl butyrate, lemonile, linalool, menthol, menthyl acetate, methyl benzoate, methyl beta naphtyl ketone, methyl dihydrojasmonate, methyl phenyl carbinyl acetate, mugetanol, muscenone delta, octahydro coumarin, octalynol, pandanol, para cresyl methyl ether, peonile, phenyl hexanol, prenyl acetate, pyranol, rose oxide, sanjinol, tetrahydrolinalool, undecalactone, verdox, vertenex, violet nitrile, Orange oil cold pressed, and combinations thereof.

The perfume composition may comprise the first perfume raw material selected from the group consisting of: allyl cyclohexane propionate, ambronate, amyl salicylate, bacdanol, benzyl acetate, benzyl propionate, benzyl salicylate, beta napthyl methyl ether, cashmeran, cetalox, cis-3-hexenol, cis-3-hexenyl acetate, cis-3-hexenyl salicylate, citronellol, citronellyl acetate, citronellyl nitrile, cyclabute, cyclogalbanate, cyclohexyl salicylate, cyclopentol, dihydro beta ionone, dihydro eugenol, dihydromyrcenol, dimethyl benzyl carbinyl acetate, dimethyl benzyl carbinyl butyrate, diphenyl oxide, ethyl amyl ketone, ethyl-2-methyl butyrate, ethyl-2-methyl pentanoate, eucalyptol, exaltolide, flor acetate, fructalate, frutene, geraniol, globanone, habanolide, heptyl acetate, hexyl acetate, hexyl salicylate, iris nitrile, iso E super, isobornyl acetate, isopropyl-2-methyl butyrate, lemonile, linalool, menthol, menthyl acetate, methyl benzoate, methyl beta naphtyl ketone, methyl dihydrojasmonate, methyl phenyl carbinyl acetate, mugetanol, muscenone delta, octahydro coumarin, octalynol, pandanol, para cresyl methyl ether, peonile, phenyl hexanol, prenyl acetate, pyranol, rose oxide, sanjinol, tetrahydrolinalool, undecalactone, verdox, vertenex, violet nitrile, and combinations thereof.

The perfume composition may comprise the first perfume raw material selected from the group consisting of: Allyl Cyclohexane Propionate, Benzyl acetate, Cashmeran, Cetalox, Cis-3-Hexenyl Acetate, cis-3-Hexenyl salicylate, Citronellol, Citronellyl Nitrile, Cyclohexyl Salicylate, Cyclopentol, Muscenone delta, Dihydro Beta Ionone, Dihydro Eugenol, Dihydro Myrcenol, Dimethyl Benzyl Carbinyl acetate, Diphenyl Oxide, Ethyl 2-Methyl pentanoate, Ethyl 2-methylbutyrate, Ethyl Amyl Ketone, Eucalyptol, Flor Acetate, Frutene, Geraniol, Globanone, Habanolide, Hexyl Acetate, Hexyl salicylate, Iso Bornyl Acetate, Iso E super, Menthol, Methyl Benzoate, Methyl Dihydro Jasmonate, Para Cresyl Methyl Ether, Peonile, Sanjinol, Tetra Hydro Linalool, Undecalactone, Verdox, Patchouli, Undecavertol, and combinations thereof.

The perfume composition may comprise the first perfume raw material selected from the group consisting of: Allyl Cyclohexane Propionate, Benzyl acetate, Cashmeran, Cetalox, Cis-3-Hexenyl Acetate, cis-3-Hexenyl salicylate, Citronellol, Citronellyl Nitrile, Cyclohexyl Salicylate, Cyclopentol, Muscenone delta, Dihydro Beta Ionone, Dihydro Eugenol, Dihydro Myrcenol, Dimethyl Benzyl Carbinyl acetate, Diphenyl Oxide, Ethyl 2-Methyl pentanoate, Ethyl 2-methylbutyrate, Ethyl Amyl Ketone, Eucalyptol, Flor Acetate, Frutene, Geraniol, Globanone, Habanolide, Hexyl Acetate, Hexyl salicylate, Iso Bornyl Acetate, Iso E super, Menthol, Methyl Benzoate, Methyl Dihydro Jasmonate, Para Cresyl Methyl Ether, Peonile, Sanjinol, Tetra Hydro Linalool, Undecalactone, Verdox, Orange oil cold pressed, and combinations thereof.

The perfume composition may comprise the first perfume raw material selected from the group consisting of: Allyl Cyclohexane Propionate, Benzyl acetate, Cashmeran, Cetalox, Cis-3-Hexenyl Acetate, cis-3-Hexenyl salicylate, Citronellol, Citronellyl Nitrile, Cyclohexyl Salicylate, Cyclopentol, Muscenone delta, Dihydro Beta Ionone, Dihydro Eugenol, Dihydro Myrcenol, Dimethyl Benzyl Carbinyl acetate, Diphenyl Oxide, Ethyl 2-Methyl pentanoate, Ethyl 2-methylbutyrate, Ethyl Amyl Ketone, Eucalyptol, Flor Acetate, Frutene, Geraniol, Globanone, Habanolide, Hexyl Acetate, Hexyl salicylate, Iso Bornyl Acetate, Iso E super, Menthol, Methyl Benzoate, Methyl Dihydro Jasmonate, Para Cresyl Methyl Ether, Peonile, Sanjinol, Tetra Hydro Linalool, Undecalactone, Verdox, and combinations thereof.

The perfume composition may comprise the first perfume raw material selected from the group consisting of: Allyl Cyclohexane Propionate, Ambronat, Benzyl acetate, Cis-3-Hexenol, Cis-3-Hexenyl Acetate, cis-3-Hexenyl Salicylate, Cyclo Galbanate, Cyclohexyl Salicylate, Cyclopentol, Dihydro Myrcenol, Dimethyl Benzyl Carbinyl acetate, Ethyl 2-methylbutyrate, Flor Acetate, Geraniol, Globanone, Habanolide, Hexyl Acetate, Hexyl salicylate, Iso E super, Methyl Dihydro Jasmonate, Peonile, Phenyl hexanol, Tetra Hydro Linalool, Undecalactone, Verdox and Verdenex, Patchouli, Undecavertol and combinations thereof.

The perfume composition may comprise the first perfume raw material selected from the group consisting of: Allyl Cyclohexane Propionate, Ambronat, Benzyl acetate, Cis-3-Hexenol, Cis-3-Hexenyl Acetate, cis-3-Hexenyl Salicylate, Cyclo Galbanate, Cyclohexyl Salicylate, Cyclopentol, Dihydro Myrcenol, Dimethyl Benzyl Carbinyl acetate, Ethyl 2-methylbutyrate, Flor Acetate, Geraniol, Globanone, Habanolide, Hexyl Acetate, Hexyl salicylate, Iso E super, Methyl Dihydro Jasmonate, Peonile, Phenyl hexanol, Tetra Hydro Linalool, Undecalactone, Verdox and Verdenex, Orange oil cold pressed, and combinations thereof.

The perfume composition may comprise the first perfume raw material selected from the group consisting of: Allyl Cyclohexane Propionate, Ambronat, Benzyl acetate, Cis-3-Hexenol, Cis-3-Hexenyl Acetate, cis-3-Hexenyl Salicylate, Cyclo Galbanate, Cyclohexyl Salicylate, Cyclopentol, Dihydro Myrcenol, Dimethyl Benzyl Carbinyl acetate, Ethyl 2-methylbutyrate, Flor Acetate, Geraniol, Globanone, Habanolide, Hexyl Acetate, Hexyl salicylate, Iso E super, Methyl Dihydro Jasmonate, Peonile, Phenyl hexanol, Tetra Hydro Linalool, Undecalactone, Verdox and Verdenex, and combinations thereof.

The perfume composition also comprises:
ii) less than 0.0005%, more preferably 0% of a second perfume raw material selected from the group consisting of: 2,6,10-trimethylundec-9-enal, citronellyl oxyacetaldehyde, 3-(4-propan-2-ylphenyl)propanal, Hexyl cinnamic aldehyde, amyl Cinnamic aldehyde, butyl Cinnamic aldehyde, 3-(1,3-benzodioxol-5-yl)-2-methylpropanal, 2-(4-methylphenyl)methylene-heptenal, 3-(4-methyl-1-cyclohex-3-enyl)butanal, melonal, 4-(4-methylpent-3-enyl)cyclohex-3-ene-1-carbaldehyde, 2,4-dimethyl-3-cyclohexene-1-carboxaldehyde, 1-methyl-4-(4-methylpentyl)cyclohex-3-ene-1-carbaldehyde, 8,8-dimethyl-6,7-dihydro-5H naphthalene-2-carbaldehyde, decyl aldehyde, nonyl aldehyde, nonadienal, octyl aldehyde, undecyl aldehyde, undecylenic aldehyde, methyl nonyl acetaldehyde, 3-(4-tert-butylphenyl)propanal, 3-(4-methoxyphenyl)-2-methylpropanal, citral, dodecylaldehyde, 3-(3-propan-2-ylphenyl)butanal, 1-(5,5-dimethyl-1-cyclohexenyl)pent-4-en-1-one, prop-2-enyl 2-cyclohexyloxyacetate, delta damascone, alpha damascone, damascenone, 5-methylhept-2-en 4-one, 6-methylhept-5-en 2-one, 2-[2-(4-methyl-1-cyclohex-3-enyl)propyl]cyclopentan-1-one, ionone alpha, beta ionone, beta damascone, iso damascone, vanillin, ethyl vanillin, and combinations thereof.

Without wishing to be bound by theory, said perfume raw materials comprise aldehyde or ketone moieties that react with alkanolamines and consequently are less effective in malodour reduction.

### Unit Dose Article

The liquid laundry detergent composition may be comprised in a unit dose article. The unit dose article comprises the liquid laundry detergent composition enclosed in a water-soluble film, wherein said water-soluble film preferably comprises polyvinyl alcohol. The unit dose article may comprise one or more compartments, wherein the liquid laundry detergent composition is contained in at least one compartment, preferably at least two compartments.

Preferably, the water-soluble film comprises: polymers, copolymers, terpolymers, or derivatives thereof, including polyvinyl alcohols (PVA) or blends of polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum, and combinations thereof. Preferably, the water-soluble film comprises polyvinyl alcohols (PVA) or blends of polyvinyl alcohols. The water-soluble film may also comprise plasticizers such as glycerin, diglycerin, sorbitol, ethylene glycol, diethylene glycol, triethylene glycol, tetraethylene glycol, propylene glycol, polyethylene glycols up to 400 Dalton (Da), neopentyl glycol, trimethylolpropane, polyether polyols, sorbitol, 2-methyl-1,3-propanediol, ethanolamines, and combinations thereof. Examples of suitable films include those commercially available from MonoSol (Merrillville, Ind., USA), such as M8630 or M8900.

The unit dose article can be of any form and shape which are suitable to hold and protect the liquid laundry detergent composition(s), e.g. without allowing the release of the detergent(s) from the article prior to contact of the article to water. The exact execution will depend on factors like the type and amount of the composition in the article, the number of compartments in the article, the characteristics required for the water-soluble film to hold, protect, and release the composition. The unit dose article may have a substantially square, rectangular, oval, elliptoid, supperelliptical, or circular shape. The shape may or may not include any excess material present as a flange or skirt at the point where two or more films are sealed together. By substantially, we herein mean that the shape has an overall impression of being for example square. It may have rounded corners and/or non-straight sides, but overall it gives the impression of being square for example.

It is preferable that the unit dose article comprise a low amount of water, hence the liquid laundry detergent composition enclosed in the unit dose article may comprise from 0.5% to 12%, preferably from 5% to 10% by weight of the liquid laundry detergent composition, of water.

The unit dose article may optionally comprise additional compartments; said additional compartments may comprise an additional composition. Said additional composition may be liquid, solid, or combinations thereof. Alternatively, any additional solid component may be suspended in a liquid-filled compartment. Each compartment may have the same or different compositions. A multi-compartment unit dose form may be desirable for such reasons as: separating chemically incompatible ingredients; or where it is desirable for a portion of the ingredients to be released into the wash earlier or later. The unit dose article may comprise at least one, or even at least two, or even at least three, or even at least four, or even at least five compartments.

The film may comprise an area of print. The area of print may cover the entire film or part thereof. The area of print may comprise a single colour or maybe comprise multiple colours, even three colours. The area of print may comprise white, black and red colours. The area of print may comprise pigments, dyes, blueing agents or combinations thereof. The print may be present as a layer on the surface of the film or may at least partially penetrate into the film.

The unit dose article may comprise at least two films, or even at least three films, wherein the films are sealed together. The area of print may be present on one film, or on more than film, e.g. on two films, or even on three films.

The area of print may be achieved using standard techniques, such as flexographic printing or inkjet printing. Preferably, the area of print is achieved via flexographic printing, in which a film is printed, and then moulded into the shape of an open compartment. This compartment is then filled with the liquid laundry detergent composition and a second film placed over the compartment and sealed to the first film. The area of print may be on either side of the film.

The area of print may be purely aesthetic or may provide useful information to the consumer.

The area of print may be opaque, translucent or transparent.

The film may comprise a bittering agent, such as Bitrex.

### Additional Ingredient

The liquid laundry detergent composition of the present invention may comprise one or more additional ingredients. Suitable additional materials include but are not limited to: anionic surfactants, cationic surfactants, nonionic surfactants, fatty acids, builders, chelating agents, dye transfer inhibiting agents, dispersants, enzymes, and enzyme stabilizers, catalytic materials, bleach activators, hydrogen peroxide, sources of hydrogen peroxide, preformed peracids, polymeric dispersing agents, clay soil removal/anti-redeposition agents, brighteners, suds suppressors, dyes, photobleaches, structure elasticizing agents, fabric softeners, carriers, hydrotropes, processing aids, solvents, hueing agents, anti-microbial agents, structurants and/or pigments.

### Anionic Surfactant

The liquid laundry detergent composition may comprise anionic surfactant. Non-limiting examples of anionic surfactants include: linear alkylbenzene sulfonate (LAS), preferably C₁₀-C₁₆ LAS; C₁₀-C₂₀ primary, branched-chain and random alkyl sulfates (AS); C₁₀-C₁₈ secondary (2,3) alkyl sulfates; sulphated fatty alcohol alkoxylates, preferably C₁₀-C₁₈ alkyl ethoxy sulfates (AEₓS) wherein preferably x is from 1-30, more preferably x is 1-3; C₁₀-C₁₈ alkyl alkoxy carboxylates preferably comprising 1-5 ethoxy units; mid-chain branched alkyl sulfates as discussed in U.S. Pat. No. 6,020,303 and U.S. Pat. No. 6,060,443; mid-chain branched alkyl alkoxy sulfates as discussed in U.S. Pat. No. 6,008,181 and U.S. Pat. No. 6,020,303; modified alkylbenzene sulfonate (MLAS) as discussed in WO 99/05243, WO 99/05242, and WO 99/05244; methyl ester sulfonate (MES); and alpha-olefin sulfonate (AOS). Preferably, the liquid laundry detergent composition comprises anionic surfactant selected from the group consisting of LAS, AEₓS, or a combination thereof. More preferably, the liquid laundry detergent composition comprises LAS.

Alkanolamines can be utilized to neutralize anionic surfactants, such as the LAS. The liquid laundry detergent composition may comprise from 5% to 95%, preferably from 10% to 50%, more preferably from 15% to 30%, by weight of the liquid laundry detergent composition of anionic surfactant. The anionic surfactant may comprise from 2% to 25%, preferably 3% to 21%, more preferably from 15% to 20% by weight of the liquid laundry detergent composition, of linear alkylbenzene sulfonate (LAS).

### Fatty Acids

Fatty acids are used as a builder. The liquid laundry detergent composition may comprise from 0.5% to 8%, preferably from 1% to 7%, more preferably from 4% to 6%, by weight of the liquid laundry detergent composition, of fatty acids. Fatty acids herein are preferably selected from those having a chain length of 6 or more carbon atoms, more preferably from the group consisting of C₁₂-C₁₈ fatty acids. As mentioned previously, the alkanolamine is utilized to neutralize acidic ingredients, such as fatty acids.

### Organic Solvent

The liquid laundry detergent composition may comprise from 1% to 45% by weight of the liquid laundry detergent composition, of an organic solvent, wherein the organic solvent preferably comprises glycerol, a diol, or a combination thereof. The organic solvent may comprise glycerol and a diol, preferably wherein the diol is propylene-diol, and wherein the composition comprises from 0.1% to 30% by weight of the liquid laundry detergent composition of glycerol and from 0.1% to 15% by weight of the liquid laundry detergent composition of the diol.

### Perfume Delivery Systems

The liquid laundry detergent composition herein may comprise perfume delivery systems. Non-limiting examples of the perfume delivery systems suitable for use herein include the following: pro-perfume compounds, perfume microcapsules (PMC), cyclodextrin, zeolite & inorganic carrier, starch encapsulated accord, amine-assisted perfume delivery system (AAD), and polyacrylate capsule. Descriptions on these perfume delivery systems can be found in US Patent Publication No. 2007/0275866 from paragraphs [0025] to [0030].

Such a combination of multiple types of perfume delivery systems allows the controlled release of a variety of different odour imparting substances, which is an advantage over slowly releasing just one perfume as will happen if just one perfume composition or perfume delivery system is used. For example, the liquid laundry detergent composition of the present invention may further comprise perfume microcapsules (PMC). PMC comprise a wall material and a core material of PRM that is encapsulated within the wall material. The PRM is not being released from the PMC until the wall material ruptures because of a mechanical stress (e.g., friction), i.e., the perfume release from the PMC is at different time points from the free perfume composition.

### Process of Making the Unit Dose Article

The process may be continuous or intermittent. The process comprises the general steps of forming an open pouch, preferably by forming a water-soluble film into a mould to form said open pouch, filling the open pouch with the liquid laundry detergent composition, closing the open pouch, preferably using a second water-soluble film to form the unit dose article. Preferably, the process is one in which a web of unit dose article are made, said web is then cut to form individual unit dose articles.

### EXAMPLES

### Example 1

Table 1 below discloses perfume raw materials providing superior malodour neutralization of fabrics without causing a colour change of the composition and their preferred ranges in the perfume composition.

TABLE 1

| Perfume raw materials | Range (wt %) |
|---|---|
| allyl cyclohexane propionate | 0.5-1.0 |
| Ambronate | 0.02-0.1 |
| amyl salicylate | 1.0-2.5 |
| bacdanol | 0.1-2.5 |
| benzyl acetate | 0.5-1.5 |
| Benzyl propionate | 0.5-1.2 |
| Benzyl salicylate | 4.0-8.0 |
| beta napthyl methyl ether | 0.1-0.2 |
| cashmeran | 0.15-0.6 |
| Cetalox | 0.05-0.75 |
| cis-3-hexenol | 0.1-0.2 |
| cis-3-hexenyl acetate | 0.2-0.6 |
| Cis-3-hexenyl salicylate | 0.25-3.0 |
| citronellol | 2.2-5.5 |
| Citronellyl acetate | 1.0-5.0 |
| Citronellyl nitrile | 0.1-0.75 |
| cyclabute | 1.0-5.0 |
| cyclogalbanate | 0.05-0.35 |
| cyclohexyl salicylate | 2.5-11.0 |
| cyclopentol | 0.1-0.5 |
| dihydro beta ionone | 1.0-4.0 |
| dihydro eugenol | 0.02-0.1 |
| dihydromyrcenol | 2.5-12.5 |
| Dimethyl benzyl carbinyl | 0.2-4.75 |
| acetate | |
| dimethyl benzyl carbinyl | 0.2-2.5 |
| butyrate | |
| Diphenyl oxide | 0.05-0.35 |
| Ethyl amyl ketone | 0.05-0.5 |
| ethyl-2-methyl butyrate | 0.08-0.6 |
| ethyl-2-methyl pentanoate | 0.08-0.3 |
| Eucalyptol | 0.25-2.5 |
| exaltolide | 0.05-0.5 |
| flor acetate | 1.0-10.0 |
| fructalate | 0.25-3.0 |
| Frutene | 1.0-10.0 |
| Geraniol | 2.0-5.0 |
| Globanone | 0.25-2.5 |
| habanolide | 0.5-5.0 |
| Heptyl acetate | 0.5-2.5 |
| heptyl acetate | 0.05-0.12 |
| Hexyl acetate | 0.5-2.5 |
| hexyl salicylate | 2.5-11 |
| Iris nitrile | 0.005-0.05 |
| Iso E super | 0.5-11 |
| Isobornyl acetate | 0.1-2.5 |
| isopropyl-2-methyl butyrate | 0.35-1.0 |
| Lemonile | 0.1-0.75 |
| linalool | 0.2-3.0 |
| menthol | 0.05-0.5 |
| menthyl acetate | 0.05-0.75 |
| methyl benzoate | 0.05-0 .25 |
| Methyl beta naphtyl ketone | 0.05-0.25 |
| methyl dihydrojasmonate | 0.5-3.0 |
| methyl nonyl acetaldehyde | 0.05-0.5 |
| Methyl phenyl carbinyl | 0.25-1.0 |
| acetate | |
| mugetanol | 0.75-2.5 |
| muscenone delta | 0.01-0.1 |
| octahydro coumarin | 0.05-1.75 |
| octalynol | 0.05-0.25 |
| orange oil cold pressed | 1.0-2.0 |
| pandanol (=keone) | 0.08-0.12 |
| para cresyl methyl ether | 0.1-0.2 |
| Patchouli | 0.05-2.5 |
| peonile | 0.25-4 |
| phenyl hexanol | 0.5-4.5 |
| Prenyl acetate | 0.05-1.5 |
| pyranol | 1.0-10.0 |
| Rose oxide | 0.05-0.5 |
| sanjinol | 0.1-2.5 |
| tetrahydrolinalool | 1.0-8.0 |
| undecalactone | 0.25-2.5 |
| undecavertol | 0.1-0.6 |
| verdox | 1.0-10.0 |
| vertenex | 1.0-7.5 |
| violet nitrile | 0.007-0.03 |

### Example 2

Table 2 below discloses a perfume composition according to the present invention.

TABLE 2

| Perfume raw materials | Range (wt %) |
|---|---|
| Allyl Cyclohexane Propionate | 0.90 |
| Ambronat | 0.10 |
| Benzyl acetate | 1.45 |
| Cis-3-Hexenol | 0.10 |
| Cis-3-Hexenyl Acetate | 0.30 |
| cis-3-Hexenyl Salicylate | 1.72 |
| Cyclo Galbanate | 0.13 |
| Cyclohexyl Salicylate | 7.50 |
| Cyclopentol | 0.15 |
| Dihydro Myrcenol | 9.00 |
| Dimethyl Benzyl Carbinyl acetate | 2.80 |
| Ethyl 2-methylbutyrate | 0.25 |
| Flor Acetate | 9.00 |
| Geraniol | 4.50 |
| Globanone | 1.10 |
| Habanolide | 4.75 |
| Hexyl Acetate | 1.25 |
| Hexyl salicylate | 9.60 |
| Iso E super | 10.30 |
| Methyl Dihydro Jasmonate | 2.75 |
| Orange oil cold pressed | 1.70 |
| Peonile | 3.00 |
| Phenyl hexanol | 4.10 |
| Tetra Hydro Linalool | 4.75 |
| Undecalactone | 2.00 |
| Verdox | 9.5 |
| Verdenex | 7.3 |
| Total: | 100 |

### Example 3

Table 3 below discloses a perfume composition according to the present invention.

TABLE 3

| Perfume raw materials | Range (wt %) |
|---|---|
| Allyl Cyclohexane Propionate | 1.10 |
| Benzyl acetate | 0.95 |
| Cashmeran | 0.38 |
| Cetalox | 0.55 |
| Cis-3-Hexenyl Acetate | 0.15 |
| cis-3-Hexenyl salicylate | 1.10 |
| Citronellol | 4.00 |
| Citronellyl Nitrile | 0.35 |
| Cyclohexyl Salicylate | 7.00 |
| Cyclopentol | 0.30 |
| Muscenone delta | 0.05 |
| Dihydro Beta Ionone | 2.30 |
| Dihydro Eugenol | 0.06 |
| Dihydro Myrcenol | 12.00 |
| Dimethyl Benzyl Carbinyl acetate | 2.30 |
| Diphenyl Oxide | 0.21 |
| Ethyl 2-Methyl pentanoate | 0.30 |
| Ethyl 2-methylbutyrate | 0.20 |
| Ethyl Amyl Ketone | 0.08 |
| Eucalyptol | 0.85 |
| Flor Acetate | 4.00 |
| Frutene | 9.00 |
| Geraniol | 3.50 |
| Globanone | 0.45 |
| Habanolide | 4.50 |
| Hexyl Acetate | 0.85 |
| Hexyl salicylate | 9.00 |
| Iso Bornyl Acetate | 0.85 |
| Iso E super | 11.00 |
| Menthol | 0.12 |
| Methyl Benzoate | 0.05 |
| Methyl Dihydro Jasmonate | 2.30 |
| Para Cresyl Methyl Ether | 0.15 |
| Patchouli | 0.60 |
| Peonile | 2.50 |
| Sanjinol | 0.50 |
| Tetra Hydro Linalool | 7.50 |
| Undecalactone | 0.45 |
| Undecavertol | 0.45 |
| Verdox | 8.00 |
| Total: | 100 |

### Example 4

The following liquid laundry detergent composition is made comprising the listed ingredients in the listed proportions (weight %):

TABLE 4

| Ingredients | w/w % |
|---|---|
| C₁₁-C₁₃HLAS | 19 |
| C₁₂-C₁₄AE₁₋₃S | 9 |
| Neodol ® 25-7 a | 15 |
| Citric acid | 0.7 |
| C₁₂-C₁₈ fatty acid | 6.2 |
| HEDP b | 2 |
| Ethoxylated Polyethyleneimine c | 5.5 |
| 1,2 propanediol | 15 |
| Glycerol | 5 |
| Monoethanolamine | 8.5 |
| Protease | 0.5 |
| Amylase | 0.1 |
| PEO-PEG grafted polymer | 1.7 |
| Potassium sulfite | 0.4 |
| Dye | 0.006 |
| Perfume composition according | 1.2 |
| to the invention | |
| Water & Minors | Add to 100 |

a Neodol ® 25-7 is C₁₂-C₁₅ alcohol ethoxylated with 7 moles of ethylene oxide as a nonionic surfactant, available from Shell
b hydroxyethylidene-1,1-diphosphonic acid as a chelant
c Polyethyleneimine (Mw = 600) ethoxylated 20 times

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition of the same term in a document incorporated by reference, the meaning of definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A liquid laundry detergent composition comprising:
a) from about 0.1% to about 15% by weight of the liquid laundry detergent composition of an alkanolamine;
b) from about 0.5% to about 3% by weight of the liquid laundry detergent composition of a perfume composition, the perfume composition comprising:
i) a first perfume raw material selected from the group consisting of: allyl cyclohexane propionate, ambronate, amyl salicylate, bacdanol, benzyl acetate, benzyl propionate, benzyl salicylate, beta napthyl methyl ether, cashmeran, cetalox, cis-3-hexenol, cis-3-hexenyl acetate, cis-3-hexenyl salicylate, citronellol, citronellyl acetate, citronellyl nitrile, cyclabute, cyclogalbanate, cyclohexyl salicylate, cyclopentol, dihydro beta ionone, dihydro eugenol, dihydromyrcenol, dimethyl benzyl carbinyl acetate, dimethyl benzyl carbinyl butyrate, diphenyl oxide, ethyl amyl ketone, ethyl-2-methyl butyrate, ethyl-2-methyl pentanoate, eucalyptol, exaltolide, flor acetate, fructalate, frutene, geraniol, globanone, habanolide, heptyl acetate, hexyl acetate, hexyl salicylate, iris nitrile, iso E super, patchouli, isobornyl acetate, isopropyl-2-methyl butyrate, lemonile, linalool, menthol, menthyl acetate, methyl benzoate, methyl beta naphtyl ketone, methyl dihydrojasmonate, Orange oil cold pressed, methyl phenyl carbinyl acetate, mugetanol, muscenone delta, octahydro coumarin, octalynol, pandanol, para cresyl methyl ether, peonile, phenyl hexanol, prenyl acetate, pyranol, rose oxide, sanjinol, tetrahydrolinalool, undecalactone and Undecavertol, verdox, vertenex, violet nitrile, and combinations thereof;
ii) less than about 0.0005% by weight of the liquid laundry detergent composition of a second perfume raw material selected from the group consisting of: 2,6,10-trimethylundec-9-enal, citronellyl oxyacetaldehyde, 3-(4-propan-2-ylphenyl)propanal, Hexyl cinnamic aldehyde, amyl Cinnamic aldehyde, butyl Cinnamic aldehyde, 3-(1,3-benzodioxol-5-yl)-2-methylpropanal, 2-(4-methylphenyl)methylene-heptenal, 3-(4-methyl-1-cyclohex-3-enyl)butanal, melonal, 4-(4-methylpent-3-enyl)cyclohex-3-ene-1-carbaldehyde, 2,4-dimethyl-3-cyclohexene-1-carboxaldehyde, 1-methyl-4-(4-methylpentyl)cyclohex-3-ene-1-carbaldehyde, 8,8-dimethyl-6,7-dihydro-5H naphthalene-2-carbaldehyde, decyl aldehyde, nonyl aldehyde, nonadienal, octyl aldehyde, undecyl aldehyde, undecylenic aldehyde, methyl nonyl acetaldehyde, 3-(4-tert-butylphenyl)propanal, 3-(4-methoxyphenyl)-2-methylpropanal, citral, dodecylaldehyde, 3-(3-propan-2-ylphenyl)butanal, 1-(5,5-dimethyl-1-cyclohexenyl)pent-4-en-1-one, prop-2-enyl 2-cyclohexyloxyacetate, delta damascone, alpha damascone, damascenone, 5-methylhept-2-en 4-one, 6-methylhept-5-en 2-one, 2-[2-(4-methyl-1-cyclohex-3-enyl)propyl]cyclopentan-1-one, ionone alpha, beta ionone, beta damascone, iso damascone, vanillin, ethyl vanillin, and combinations thereof.

2. The liquid laundry detergent composition according to claim 1, wherein the perfume composition comprises the first perfume raw material selected from the group consisting of: allyl cyclohexane propionate, ambronate, amyl salicylate, bacdanol, benzyl acetate, benzyl propionate, benzyl salicylate, beta napthyl methyl ether, cashmeran, cetalox, cis-3-hexenol, cis-3-hexenyl acetate, cis-3-hexenyl salicylate, citronellol, citronellyl acetate, citronellyl nitrile, cyclabute, cyclogalbanate, cyclohexyl salicylate, cyclopentol, dihydro beta ionone, dihydro eugenol, dihydromyrcenol, dimethyl benzyl carbinyl acetate, dimethyl benzyl carbinyl butyrate, diphenyl oxide, ethyl amyl ketone, ethyl-2-methyl butyrate, ethyl-2-methyl pentanoate, eucalyptol, exaltolide, flor acetate, fructalate, frutene, geraniol, globanone, habanolide, heptyl acetate, hexyl acetate, hexyl salicylate, iris nitrile, iso E super, isobornyl acetate, isopropyl-2-methyl butyrate, lemonile, linalool, menthol, menthyl acetate, methyl benzoate, methyl beta naphtyl ketone, methyl dihydrojasmonate, methyl phenyl carbinyl acetate, mugetanol, muscenone delta, octahydro coumarin, octalynol, pandanol, para cresyl methyl ether, peonile, phenyl hexanol, prenyl acetate, pyranol, rose oxide, sanjinol, tetrahydrolinalool, undecalactone, verdox, vertenex, violet nitrile, and combinations thereof.

3. The liquid laundry detergent composition according to claim 1, comprising from about 0.5% to about 12% by weight of the liquid laundry detergent composition of the alkanolamine.

4. The liquid laundry detergent composition according to claim 3 wherein the alkanolamine comprises mono ethanol amine, propaneolamine, triethanolamine, and combinations thereof.

5. The liquid laundry detergent composition according to claim 1, comprising from about 0.9% to about 2.5% by weight of the liquid laundry detergent composition, of the perfume composition.

6. The liquid laundry detergent composition according to claim 1, wherein the perfume composition comprises the first perfume raw material selected from the group consisting of: Allyl Cyclohexane Propionate, Benzyl acetate, Cashmeran, Cetalox, Cis-3-Hexenyl Acetate, cis-3-Hexenyl salicylate, Citronellol, Citronellyl Nitrile, Cyclohexyl Salicylate, Cyclopentol, Muscenone delta, Dihydro Beta Ionone, Dihydro Eugenol, Dihydro Myrcenol, Dimethyl Benzyl Carbinyl acetate, Diphenyl Oxide, Ethyl 2-Methyl pentanoate, Ethyl 2-methylbutyrate, Ethyl Amyl Ketone, Eucalyptol, Flor Acetate, Frutene, Geraniol, Globanone, Habanolide, Hexyl Acetate, Hexyl salicylate, Iso Bornyl Acetate, Iso E super, Menthol, Methyl Benzoate, Methyl Dihydro Jasmonate, Para Cresyl Methyl Ether, Patchouli, Peonile, Sanjinol, Tetra Hydro Linalool, Undecalactone and Undecavertol, Verdox and combinations thereof.

7. The liquid laundry detergent composition according to claim 1, wherein the perfume composition comprises the first perfume raw material selected from the group consisting of: Allyl Cyclohexane Propionate, Ambronat, Benzyl acetate, Cis-3-Hexenol, Cis-3-Hexenyl Acetate, cis-3-Hexenyl Salicylate, Cyclo Galbanate, Cyclohexyl Salicylate, Cyclopentol, Dihydro Myrcenol, Dimethyl Benzyl Carbinyl acetate, Ethyl 2-methylbutyrate, Flor Acetate, Geraniol, Globanone, Habanolide, Hexyl Acetate, Hexyl salicylate, Iso E super, Methyl Dihydro Jasmonate, Orange oil cold pressed, Peonile, Phenyl hexanol, Tetra Hydro Linalool, Undecalactone, Verdox and Verdenex and combinations thereof.

8. The liquid laundry detergent composition according to claim 1, wherein the perfume composition comprises about 0% of the second perfume raw material.

9. The liquid laundry detergent composition according to claim 1, comprising from about 1% to about 45% by weight of the liquid laundry detergent composition of an organic solvent.

10. The liquid laundry detergent composition according to claim 9, wherein the organic solvent comprises glycerol, a diol, and combinations thereof.

11. The liquid laundry detergent composition according to claim 9, wherein the organic solvent comprises glycerol and a diol, wherein the diol is propylene-diol, and wherein the composition comprises:
a. from about 0.1% to about 30% by weight of the liquid laundry detergent composition of the glycerol,
b. from about 0.1% to about 15% by weight of the liquid laundry detergent composition of the diol.

12. The liquid laundry detergent composition according to claim 1, comprising from about 5% to about 95%, by weight of the liquid laundry detergent composition, of anionic surfactant.

13. The liquid laundry detergent composition according to claim 10, wherein the anionic surfactant comprises from about 2% to about 25%, by weight of the liquid laundry detergent composition, of linear alkylbenzene sulfonate (LAS)

14. The liquid laundry detergent composition according to claim 1, comprising from about 0.5% to about 8%, by weight of the liquid laundry detergent composition, of fatty acids, preferably selected from the group consisting of C₁₂-C₁₈ fatty acids.

15. The liquid laundry detergent composition according to claim 1, wherein the liquid laundry detergent composition has a pH of from about 7 to about 9, measured after diluted to about 10% in water, at about 25° C.

16. A unit dose article comprising the liquid laundry detergent composition according to claim 1 enclosed in a water soluble film, wherein said water-soluble film preferably comprises polyvinyl alcohol.

17. The unit dose article according to claim 13, comprising two or more compartments, wherein the liquid laundry detergent composition is contained in at least one compartment, preferably at least two compartments.

18. The unit dose article according to claim 13, wherein the liquid laundry detergent composition comprises from about 0.5% to about 12%, by weight of the composition of water.
